(19) United States
(12) Patent Application Publication
(10) Pub. No.: US 2025/0057061 A1
(43) Pub. Date: Feb. 20, 2025

(54) SYSTEM AND METHOD FOR AUTONOMOUS ELECTRIC TILLAGE IMPLEMENT

(71) Applicant: CNH Industrial America LLC, New Holland, PA (US)

(72) Inventor: Ramesh Chandra Mokkarala, Pewaukee, WI (US)

(21) Appl. No.: 18/241,015

(22) Filed: Aug. 31, 2023

Related U.S. Application Data
(60) Provisional application No. 63/533,297, filed on Aug. 17, 2023.

(51) Int. Cl. A01B 33/02; A01B 33/08

(52) U.S. Cl. CPC A01B 33/024; A01B 33/082; A01B 33/087

(57) ABSTRACT

A tillage implement may include at least one electric motor coupled to a ground engaging tool, a power storage component configured to store power and to provide the power to the at least one electric motor, and a controller communicatively coupled to the at least one electric motor and the power storage component. The controller comprises a memory and a processor and the controller may provide instructions to the at least one electric motor to adjust a rotational speed of the ground engaging tool, an angle of the ground engaging tool relative to a soil surface, or both.

### CROSS-REFERENCE TO RELATED APPLICATION

This application claims priority to U.S. Provisional Application No. 63/533,297, filed Aug. 17, 2023, entitled “SYSTEM AND METHOD FOR AUTONOMOUS ELECTRIC TILLAGE IMPLEMENT,” the disclosure of which is incorporated by reference in its entirety for all purposes.

### BACKGROUND

The present disclosure relates to agricultural tillage systems, and more specifically, to systems and methods for an autonomous electric tillage implement.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Certain agricultural implements include ground engaging tools configured to interact with soil. For example, a tillage implement includes ground engaging tools (e.g., disc blades, roto tillers, tines) configured to break up the soil to prepare the soil for planting operations and/or seeding operations. In certain instances, the tillage implement may be expensive to maintain and may involve frequent maintenance by skilled operators. For example, the ground engaging tools may become clogged during tilling operations, which may leave untilled rows in the soil and prompt frequent maintenance. In addition, tire tracks left by the tillage implement may compact the soil, which may impact seed germination and/or seed placement accuracy. As such, additional tilling and/or leveling may be used to counter the tire tracks, which increases costs associated with tilling. Accordingly, a system and method for a cost-effective tillage implement for tilling operations may be desired.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In an embodiment, a tillage implement may include at least one electric motor coupled to a ground engaging tool, a power storage component configured to store power and to provide the power to the at least one electric motor, and a controller communicatively coupled to the at least one electric motor and the power storage component. The controller comprises a memory and a processor and the controller may provide instructions to the at least one electric motor to adjust a rotational speed of the ground engaging tool, an angle of the ground engaging tool relative to a soil surface, or both.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of a tillage implement for working a field;

FIG. 2 is a perspective view of an embodiment of the tillage implement of FIG. 1 communicatively coupled to a controller;

FIG. 3 is a circuit diagram representative of an embodiment of the tillage implement of FIG. 1 including a battery pack, a solar panel, and one or more electric motors;

FIG. 4 is a flowchart of an example method for operating the tillage implement of FIG. 1;

FIG. 5 is a close-up view of an embodiment of a ground engaging tool of the tillage implement of FIG. 1 as a rotary tine;

FIG. 6 is a close-up view of an embodiment of a ground engaging tool of the tillage implement of FIG. 1 as a roto tiller assembly;

FIG. 7 a close-up view of an embodiment of a ground engaging tool of the tillage implement of FIG. 1 as a roller;

FIG. 8 is a flowchart of an example method for operating the tillage implement of FIG. 1 based on sensor data indicative of soil characteristics; and

FIG. 9 is a flowchart of an example method for operating the tillage implement of FIG. 1 based on sensor data indicative of operating parameters of a ground engaging tool.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

The process of farming involves tilling soil of a field prior to planting seeds. Tilling the soil is accomplished using a wide variety of tillage systems, such as a strip tillage implement for tilling soil in strips, a field cultivator for tilling and leveling the tilled soil, and so on. To this end, a tillage implement includes a frame coupled to a number of brackets, which can carry various ground engaging tools for engaging the soil when pulled across the field, thereby tilling the soil. The ground engaging tools may include shovels, knives, points, sweeps, coulters, spikes, or plows, for example. Each tool performs a function intended to convert compacted soil into a level seedbed with consistent depth for providing desirable seeding conditions for planting and/or seeding operations.

In certain embodiments disclosed herein, the tillage implement may be at least partially automated (e.g., partially independent of human control) to till the soil. The tillage implement may include a controller (e.g., control system) that allows an operator to input one or more operating parameters (e.g., characteristics) of the tillage implement. For example, the operator can set a desired command, such as a target speed of the tillage implement, a target depth of a respective ground-engaging tool, a portion of the field for tilling, and the like. In another example, the operator can individually set a target angle, a target rotational speed, a target depth, and the like for each ground engaging tool. The controller may maintain inputted command(s) (e.g., previously entered, stored) during tilling operations. Additionally, in certain instances, the field may not be uniform in soil conditions, and the controller may adjust operation of the tillage implement based on the soil conditions. For example, the controller may receive sensor data from one or more sensors coupled to the tillage implement. The controller may determine the soil conditions from the sensor data and adjust operation of the tillage implement based on the soil conditions to maintain the inputted command(s) during the tilling operations given the soil conditions.

In addition, the tillage implement may operate using one or more electric motors, thereby reducing cost and/or carbon emissions during the tilling operations. For example, the one or more electric motors may be powered by a battery pack coupled to a frame of the tilling implement. The one or more electric motors are also coupled to the ground engaging tools and drive the ground engaging tools to perform the tilling operations. The combination of the electric motor and the ground engaging tools acts as a power roto-tilling tool and may provide aggressive tilling to the soil, thereby improving tilling operations. In addition, the ground engaging tools help maneuver the tilling implement through the field during the operation, thereby reducing a number of steps involved in the tillage operations. During the tillage operations, the controller may monitor an amount of power remaining in the battery pack. If the amount of power is below a power threshold, then the controller may instruct the tillage implement to return to a charging station for charging. In certain instances, the battery pack may not include enough power to return the tillage implement to the charging station. The tillage implement includes one or more solar panels coupled to the frame, which provide a backup power source for the tillage implement to return to the charging station. In this way, the tillage implement operates autonomously or semi-autonomously, reduces carbon emissions, and/or improves seeding operations, which may reduce operational costs of the tillage implement.

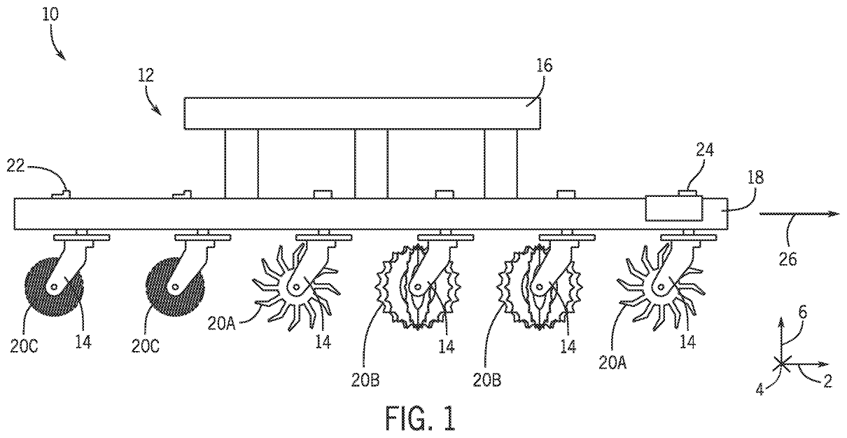

With the foregoing in mind, FIG. 1 is a side view of an embodiment of a tillage implement 10 for working a field. To facilitate discussion, the tillage implement 10 may be described with reference to a longitudinal axis or direction 2, a lateral axis or direction 4, and a vertical axis or direction 6. In the illustrated embodiment, the tillage implement 10 includes a frame 12 and a number of brackets 14 (e.g., mounting sub-frames) for carrying ground engaging tools 20. The frame 12 includes a top section 16 and a bottom section 18. The top section 16 and/or the bottom section 18 may support a power system with one or more solar panels, a battery pack, one or more sensors, one or more electric motors, and the like. For example, the top section 16 may be coupled to the one or more solar panels that generate electrical power that is stored in a battery pack coupled to the bottom section 18. In another example, the bottom section 18 may be coupled (e.g., rotatably coupled) to the brackets 14 for performing ground breaking operations. While the frame 12 includes the top section 16 and the bottom section 18 in the illustrated embodiment, in other embodiments, the frame 12 may include more or fewer sections, such as one section, three or more sections, four or more sections, five or more sections, and so on. In certain embodiments, the frame 12 may be substantially rigid (e.g., not including any translatable and/or rotatable components). Furthermore, the frame 12 may be formed from multiple frame elements (e.g., rails, tubes, braces) coupled to one another (e.g., via fastener(s), such as bolts and/or welded connections).

As illustrated, the tillage implement 10 includes the brackets 14 coupled to the frame 12 and the ground engaging tools 20. A top end portion of the brackets 14 is coupled to the frame 12 and a bottom end portion of the brackets 14 mount (e.g., rotatably mount) the ground engaging tools 20. The brackets 14 may be coupled to the frame 12 using brackets and/or fasteners (e.g., bolts, hooks, pins, clamps, straps). As such, an operator may quickly and easily swap the brackets 14 and/or the ground engaging tools 20 for working the field. For example, the operator may individually mount and/or remove one cultivator shank 14 and/or one ground engaging tool 20 before, during, or after the operation.

To perform the tilling operations, the ground engaging tools 20 engage with a surface of the soil. The ground engaging tools 20 may include plow blades, disc blades, tines, spikes, spokes, sweeps, chisel points, and so on. For example, the ground engaging tools 20 may include a series of blades and/or tines that rotate about a horizontal axis. In certain instances, the ground engaging tools 20 may include secondary ground engaging tools, such as level blades, rollers, crumblers, basket assemblies, and the like for leveling the soil. For example, the ground engaging tools may include a roller to level and/or compress the soil. In addition, the roller may support movement of the tillage implement 10 throughout the field, which may eliminate the use of additional tilling or leveling operations. To drive the ground engaging tools 20, the tillage implement 10 may include at least one electric motor 22 coupled to the ground engaging tool 20, the frame 12, the brackets 14, or any combination thereof. For example, the tillage implement 10 may include one electric motor 22 connected between the frame 12 and one or more of the ground engaging tools 20 to drive the one or more of the ground engaging tools 20. In another example, the tillage implement 10 may include one electric motor 22 coupled to a respective cultivator shank 14 and a respective ground engaging tool 20 to drive the respective ground engaging tool 20.

As illustrated, the tillage implement 10 includes six rows of the ground engaging tools 20, such as two rows of rotary tines 20A, two rows of roto tiller assemblies 20B, and two rows of rollers 20C. Further, each row of the ground engaging tools 20 may include any number of the ground engaging tools 20 distributed across the lateral axis 4, and each of the ground engaging tools 20 is coupled to a respective cultivator shank 14. As the tillage implement 10 moves in a forward direction 26 through the field, the ground engaging tools 20 are driven to rotate relative to the frame 12, thereby breaking up a top layer of the soil. For example, the ground engaging tools 20 may be set to a target depth and/or a target rotational speed for breaking up the top layer of the soil. In the illustrated embodiment, the rotary tine 20A and the roto tiller assembly 20B are positioned in a forward section of the tillage implement 10 and engage with the field to break up the soil. To reduce a number of tillage operations, the tillage implement 10 includes the two rollers 20C positioned in a rearward section of the tillage implement 10 to support movement and/or at least a portion of a weight of the tillage implement 10. The rollers 20C may also level and/or compress the soil subsequent to tilling by the rotary tines 20A and the roto tiller assemblies 20B. In this way, the tillage implement 10 may reduce a number of tilling operations, which may improve operational efficiency. Although the illustrated embodiment includes three types of ground engaging tools 20, the tillage implement 10 may include any suitable type of ground engaging tools 20 in any suitable combination and/or arrangement (e.g., any number of types distributed in any number of rows, and with each of the rows including any number of ground engaging tools 20). For example, the tillage implement 10 may include two or more rows of ground engaging tools 20, three or more rows of ground engaging tools 20, four or more rows of ground engaging tools 20, five or more rows of ground engaging tools 20, and so on. As discussed herein, the operator may quickly and easily swap certain ground engaging tools 20 for other ground engaging tools 20. In certain embodiments, the tillage implement 10 may be devoid of wheel assemblies (e.g., traditional tracks or tires) movably coupled to the frame 12. However, the tillage implement 10 may include wheel assemblies, and in such cases, the wheel assemblies engage with the surface of the soil and support at least a portion of the weight of the tillage implement 10.

In the illustrated embodiment, a sensor 24 is coupled to the tillage implement 10, such as at a locality proximate to the ground engaging tools 20. The sensor 24 may include a capacitive sensor, an optical sensor, a light detection and ranging (LIDAR) sensor, a proximity sensor, an ultrasound sensor, a radar sensor, a sonar sensor, a location sensor (e.g., global positioning system (GPS) sensor), an accelerometer sensor, a speed (e.g., velocity) sensor, a position sensor, a carbon sensor, a compaction layer sensor, a ground penetrating radar sensor, or any combination thereof. The sensor 24 may couple to the frame 12, the brackets 14, or some other structure located near the ground engaging tools 20. In certain instances, the sensor 24 monitors soil conditions. For example, the tillage implement 10 may include a first sensor 24 positioned (e.g., at the forward section of the tillage implement 10) to monitor the soil prior to the tilling operations and a second sensor 24 positioned (e.g., at the rearward section of the tillage implement 10) to monitor the soil after the tilling operations. As such, the sensor 24 monitors a change in soil conditions due to passage of the tilling implement 10. For example, the sensor 24 monitors soil and crop characteristics, such as soil density, soil texture, soil color, soil moisture, soil carbon levels, carbon levels sequestered in crop residues, particle sizes of the soil, compactness of the soil, a moisture level of the soil, a carbon level of the soil, and so on. In other instances, the sensor 24 detects presence of objects and/or obstacles within the field. The sensor 24 may detect presence of people, work vehicles, cars, animals, and the like in the field to reduce and/or eliminate collisions of the tillage implement 10. In another example, the sensor 24 may monitor the soil for obstacles, such as rocks, tree roots, stumps, crop residue, wet soil, clay soil, and the like to reduce and/or eliminate damage to the ground engaging tools 20 during the tilling operations. Additionally or alternatively, the sensor 24 monitors a location of the tillage implement 10 within the field, such via GPS coordinates, a speed (e.g., velocity) of the tillage implement 10 during the operation, and the like. Still in other instances, the sensor 24 monitors operating conditions of the ground engaging tools 20. For example, the sensor 24 may be positioned such that a signal transmitted from the sensor 24 intersects with a portion of a respective ground engaging tool 20. The sensor 24 may monitor an angle between the ground engaging tool 20 and the soil, a rotational speed, a depth, a profile, and the like. For example, the sensor 24 may be an optical sensor that generates image data (e.g., as the sensor data) of the ground engaging tools 20. The sensor 24 generates the sensor data over a period of time to detect changes in the soil conditions, changes in the ground engaging tools 20 (e.g., a status, such as operational, damaged, worn) of the ground engaging tools 20, and so on.

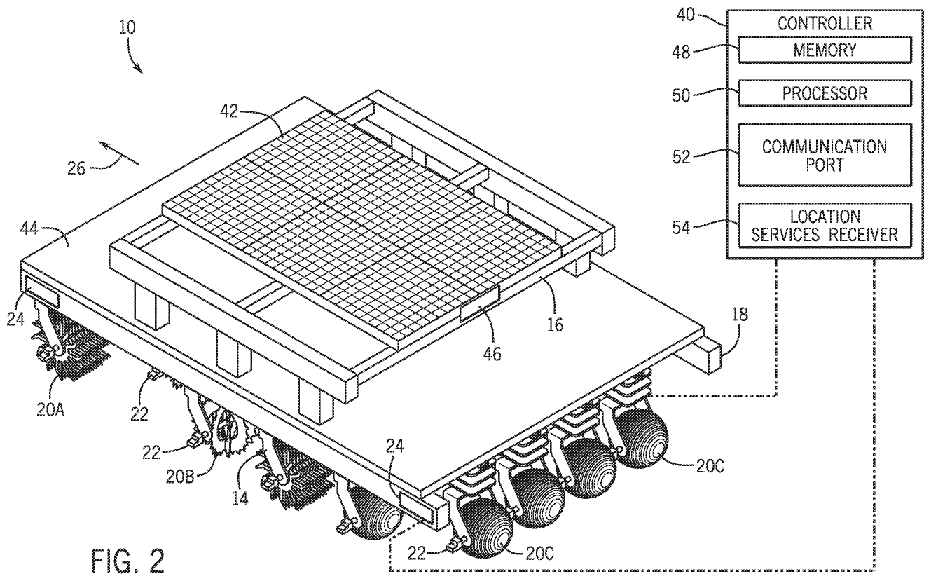

FIG. 2 is a perspective view of an embodiment of the tillage implement 10 communicatively coupled to a controller 40 (e.g., control system). As illustrated, the tillage implement 10 includes multiple rows of the ground engaging tools 20. With respect to the forward direction 26 of the tillage implement 10, the ground engaging tools 20 include a first row (e.g., a front-most row) of rotary tines 20A, a second row and a third row of the roto tiller assemblies 20B, a fourth row of rotary tines 20D, and a fifth row and a sixth row (e.g., a rear-most row) of rollers 20C. The ground engaging tools 20 are coupled to one or more electronic motors 22 that drive the ground engaging tools 20. In certain embodiments, each of the ground engaging tools 20 is coupled to a respective electric motor 22 that drives the ground engaging tool 20.

In certain embodiments, each ground engaging tool 20 is coupled to a respective sensor 24 that monitors operational parameters of the ground engaging tool. The tillage implement 10 includes a battery pack 42 (e.g., power storage component; one or more rechargeable batteries), which may be mounted to the top section 16. The tillage implement 10 may also include one or more solar panels 44, which may be mounted to the bottom section 18. The battery pack 42 provides power to the one or more electric motors 22 to drive the ground engaging tools 20 and/or provides power to the sensors 24 for generating sensor data and/or provides power to the controller 40, for example. In certain embodiments, the battery pack 42 and/or the one or more solar panels 44 are the only sources of power for the tillage implement 10 (e.g., to drive the ground engaging tools 20 during the tilling operations).

The battery pack 42 may be a lithium ion battery, a nickel metal hydride battery, a lead acid battery, and the like. The battery pack 42 may include a charging port 46 that couples to a charging station (e.g., wall outlet; during storage; between tilling operations). The controller 40 may control the tillage implement 10 to travel to the charging station and/or to move the charging port 46, such as to autonomously plug itself into the charging station to charge the battery pack 42 and/or to unplug itself when the battery pack 42 is fully charged. In certain instances, the charging port 46 may unplug itself when an amount of power within the battery pack 42 is above a charge threshold to decrease charging time. For example, if only an area (e.g., a quarter of the field; square meters) is to undergo the tilling operations, then the controller 40 may calculate and/or access (e.g., from a lookup table) the charge threshold that will provide sufficient power to complete the tilling operations for the area. In some cases, the controller 40 may take into account various factors, such as operator inputs or preferences, the soil conditions, prior power usage rates for the tillage implement 10 in the field and/or in other fields, prior power usage rates for other tillage implements in the field and/or in other fields, current or future weather conditions (e.g., sun or light), current or predicted power generation rate by the solar panels 44, models, and/or other sources, to calculate the charge threshold based on the area.

In certain instances, the battery pack 42 may run out of power during the tilling operations. As such, power generated by the solar panels 44 are used to power the tillage implement 10. For example, the tillage implement 10 may operate in a low power mode when returning to the charging station. That is, power from the solar panels 44 may be used to power the one or more electric motors 22 to provide maneuvering of the tillage implement 10 back to the charging station. In this way, the operational costs of the tillage implement 10 may be reduced. In some embodiments, the controller 40 may allow the tilling operations to continue until the battery pack 42 drains the power obtained via the connection between the charging port 46 and the charging station as long as the controller 40 determines that the current or predicted power generation rate by the solar panels 44 (and/or stored power from the solar panels 44) is sufficient to return the tillage implement to the charging station. Thus, the controller 40 may operate the tillage implement 10 in a smart, dynamic manner to complete the tilling operations with fewer returns to the charging station, for example (e.g., only after the battery pack 42 is drained of power).

It should be appreciated that the controller 40 may also operate the tillage implement 10 in other ways and/or according to other programmed settings. For example, in response to determining that the current or predicted power generation rate by the solar panels 44 (and/or stored power from the solar panels 44) is insufficient to return the tillage implement to the charging station, the controller 40 may determine the amount of power that will be utilized to return the tillage implement 10 to the charging station and then control the tillage implement 10 to return to the charging station based on this parameter, a remaining amount of power in the battery pack 42, and/or any available power predicted via the solar panels 44.

In certain instances, the solar panels 44 may generate power during the tilling operations for storage in the battery pack 42. A portion of the battery pack 42 may store back up power generated by the solar panels 44, which may be used for returning the tillage implement 10 to the charging station and/or for other purposes (e.g., to supplement the power from other sources and stored in the battery pack 42). In other instances, the solar panels 44 may include a battery storage system that stores the generated electricity for subsequent use, such as returning the tillage implement 10 to the charging station on a cloudy day. In this way, the operations may not be limited to the amount of power within the battery pack 42 and/or obtained via a connection between the charging port 46 and the charging station. Although the illustrated embodiment includes the battery pack 42 mounted to the top section 16 and the solar panels 44 mounted to the bottom section 18, in other embodiments, the solar panels 44 is mounted to the top section 16 and the battery pack 42 is mounted to the bottom section 18. Indeed, the battery pack 42 and the solar panels 44 may be positioned at any suitable location (e.g., side-by-side on the top section 16 or the bottom section 18, on other structures, and so forth).

Returning to the controller 40, the controller 40 may at least partially autonomously control operation of the tillage implement 10. The controller 40 may include a memory 48, a processor 50 (e.g., microprocessor), a communication port 52, and a location services receiver 54. The memory 48 may store a variety of information and may be used for various purposes. For example, the memory 48 may store processor-executable instructions (e.g., firmware or software) for the processor 50 to execute, such as instructions for autonomously controlling the tillage implement 10. In another example, the memory 48 may store one or more operating parameters of the ground engaging tools 20, a map and/or location data for autonomously instructing the tillage implement 10, a yield map including crop yield by geographic position, field agronomy data from soil measurements, and the like. The memory 48 may store one or more target traces indicative of a status of the ground engaging tools 20. The target traces may correspond to a type of ground engaging tool 20, a size of the ground engaging tool 20, a surface texture of the ground engaging tool 20, and so on. Moreover, the processor 50 may include multiple microprocessors, one or more “general-purpose” microprocessors, one or more special-purpose microprocessors, and/or one or more application specific integrated circuits (ASICS), or some combination thereof. For example, the processor 50 may include one or more reduced instruction set (RISC) or complex instruction set (CISC) processors. The memory 48 may include a volatile memory, such as random access memory (RAM), and/or a nonvolatile memory, such as read-only memory (ROM). The memory 48 and/or the processor 50, or an additional memory and/or processor, may be located in any suitable portion of the tillage implement 10 or, in some embodiments, operable connected to the tillage implement 10.

To facilitate the communication, the controller 40 includes the communication port 52. The communication port 52 supports communication between the controller 40, the tillage implement 10 (e.g., components of the tillage implement 10, such as an on-board computing system, the one or more electric motors 22, the sensors 24, the battery pack 42, and/or the solar panels 44), a mobile device of the operator via Bluetooth, Near Field Communication (NFC), sidelink, Bluetooth, wireless communication networks, and so on. The communication port 52 also supports inputs from the operator and the controller 40. For example, the operator may access the controller 40 and/or transmit instructions, such as operating parameters, to the controller 40, via an application or a browser on a mobile device. The controller 40 may transmit, via the communication port 52, a signal (e.g., control signal) to the tillage implement 10 to operate based on the operating parameters. The operating parameters may include a target speed of the tillage implement 10, a portion of the field for tilling operations, a target rotational speed of the ground engaging tools 20, a target depth of the ground engaging tools 20, a target angle of the ground engaging tools 20, a path for the tillage implement 10, a location for operation, and so on. In certain embodiments, the ground engaging tools 20 can be individually controlled. As such, the operator may set operating parameters for a respective ground engaging tools 20, a group of the ground engaging tools 20, or all of the ground engaging tools 20, and the controller 40 may transmit a signal via the communication port 52 to the tillage implement 10 based on the operating parameters. Moreover, the controller 40 is communicatively coupled to the sensors 24 coupled to the tillage implement 10. The controller 40 may receive, via the communication port 52, sensor data from the sensors 24. For example, the sensors 24 may include ground penetrating radar sensors for sensing depth of a compaction layer of soil. The controller 40 may consider the sensor data and the operating parameters (e.g., make a comparison) and transmit a signal to adjust the operating parameters of one or more ground engaging tools 20. In another example, the sensors 24 may be an optical sensor monitoring an operating status of the ground engaging tools 20. The controller 40 may receive the sensor data and determine one or more ground engaging tools 20 are inoperable due to soil clogging the ground engaging tools 20, obstacles damaging the ground engaging tools 20, or the like. As such, the controller 40 may provide an indication to the operator to perform maintenance, control the tillage implement 10 to return to a base station (e.g., the charging station) or to a location of the operator and/or requested by the operator, and/or control the tillage implement 10 to perform auto-maintenance (e.g., lift the inoperable ground engaging tools 20 from the soil and rotate at a high speed, or other appropriate action). In certain instances, the controller 40 may be configured to control operation of the sensors 24 (e.g., turning the sensors on/off, adjusting sensor settings, cause rotation of the sensors relative to the frame 12) to obtain additional sensor data, reduce further alerts to conserve power, and so forth.

The controller 40 also includes the location services receiver 54 to determine a position (e.g., location) of the tillage implement 10. The location services receiver 54 may communicatively couple to satellites, cell towers, base stations, Wi-Fi access points (if available), and the like. For example, the location services receiver 54 may couple to a satellite and provide GPS coordinates indicative of the position of the tillage implement 10. In another example, the location services receiver 54 may continuously track the position of the tillage implement 10, and the controller 40 may populate a graphical user interface (GUI) including a map and the location of the tillage implement 10. In this way, the location services receiver 54 may monitor the position of the tillage implement 10 during the tilling operations. In an embodiment, the controller 40 is mounted to the top section 16 or the bottom section 18, and the location services receiver 54 monitors the position of the tillage implement 10 during the tilling operations. In other embodiments, the controller 40 is remotely located and communicatively coupled to the tillage implement 10. The controller 40 may also represent a distributed controller that includes multiple controllers and/or computing systems that each include one or more processors that are programmed to carry out various functions and operations described herein (e.g., control of the tillage implement 10, processing of sensor data, calculations related to power usage and/or thresholds, communication with mobile devices associated with operators, communication with weather forecasting systems, and so forth). The sensors 24 may include position sensors that generate position data of the tillage implement 10 and the controller 40 may monitor the position of the tillage implement 10 based on the sensor data.

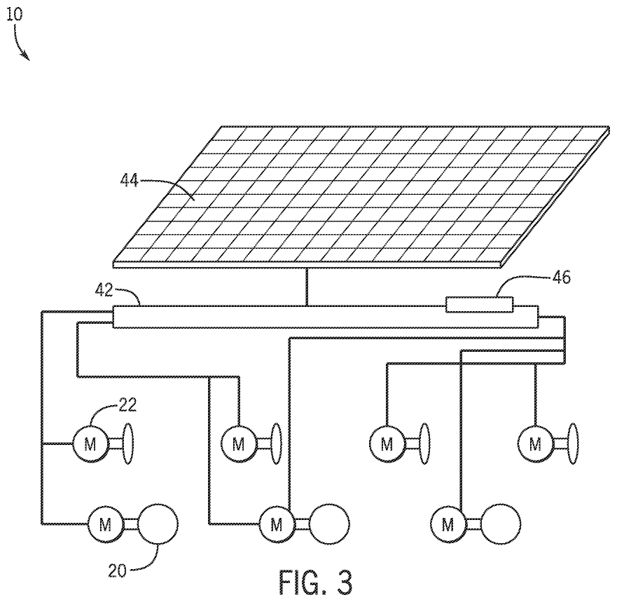

FIG. 3 is a circuit diagram of an embodiment of the tillage implement 10 including the battery pack 42, the solar panel 44, and the one or more electric motors 22. In the illustrated embodiment, the solar panel 44 is positioned on the top portion 16, and the battery pack 42 is positioned on the bottom portion 18, thereby increasing an exposed surface area of the solar panel 44. As discussed herein, power from the solar panel 44 may be used as back up, and power from the battery pack 42 may be the main power source. The solar panel 44 and the battery pack 42 may be connected such that the solar panel 44 provides power to be stored in the battery pack 42. If the amount of power within the battery pack 42 is below a power threshold and/or equal to zero, the solar panel 44 may activate to generate power (e.g., to power component of the tillage implement 10 and/or for storage in the battery pack 42). Power from the solar panel 44 may be used to drive the tillage implement 10 to the charging station. At the charging station, the charging port 46 may plug itself into the charging station and initiate charging the battery pack 42. The charging station may be a super charging station or a low charging station that provides electrical energy for the battery pack 42. Once charged, the battery pack 42 provides power to each of the one or more electric motors 22 to drive the ground engaging tools 20.

In certain instances, the controller 40 may transmit an indication to the operator to perform maintenance on the tillage implement 10 while the tillage implement 10 is charging. For example, the controller 40 transmits a notification to the operator (e.g., GUI displayed on a mobile device) to indicate that the tillage implement 10 is at the charging station and that one or more ground engaging tools 20 are clogged and/or damaged. The notification may also indicate a position of the clogged ground engaging tools 20 relative to the tillage implement 10, which may improve operational efficiency. As such, the operator may quickly and easily inspect and/or unclog the clogged ground engaging tools 20 and/or switch out the ground engaging tools 20. Still in other instances, the operator may switch positions of one or more ground engaging tools 20 to adjust operation of the tillage implement 10. For example, the operator may want a more aggressive tillage operation and install additional ground engaging tools 20.

Returning to the tillage implement 10, each of the one or more electric motors 22 is coupled to a respective ground engaging tool 20. The one or more electric motors 22 receive electrical power from the battery pack 42 and convert the energy into mechanical energy, such as by driving a respective ground engaging tool 20. To this end, the one or more electric motors 22 may each include one or more coils and/or magnets to drive the ground engaging tools 20. Moreover, the one or more electric motors 22 may adjust operational parameters of the ground engaging tools 20, such as an angle, a depth, a speed, and the like (e.g., by adjusting position of the ground engaging tools 20 relative to the frame 12 of the tillage implement 10 and/or adjusting rotational speed of the ground engaging tools 20).

As discussed herein, the ground engaging tools 20 may be individually controlled, such as by a respective electric motor 22. By way of example, the controller 40 may determine that a respective ground engaging tool 20 is applying less force (e.g., torque) than the target operating parameters. The controller 40 may then determine an amount of force to be applied by the respective ground engaging tool 20 to meet the operating parameters and transmit a signal to the respective electric motor 22 to drive the ground engaging tool 20. In this way, the tillage implement 10 may operate based on target operating parameters. In another example, the controller 40 may identify an obstacle in a path of one or more ground engaging tools 20 that may damage the ground engaging tool 20. The controller 40 may transmit a signal to one or more electric motors 22 to adjust the position of the ground engaging tool 20 in the vertical direction to avoid contact with the obstacle. For example, the ground engaging tool 20 may be raised in the vertical direction, an angle of the ground engaging tool 20 may be adjusted relative to the forward direction of travel, a rotational speed of the ground engaging tool 20 may be adjusted, and so on. After a period of time, the controller 40 may transmit an additional signal to the one or more electric motors 22 to adjust the position of the ground engaging tool 20, such that the ground engaging tool 20 may engage with the soil. As such, damage to the ground engaging tools 20 may be reduced.

Still in another instance, the ground engaging tool 20 may be clogged, and therefore, may not perform the tilling operations. To reduce resistance caused by dragging the clogged ground engaging tool 20 through the field, the controller 40 may transmit a signal to the respective electric motor 22 to raise the ground engaging tool 20 in the vertical direction to separate from the soil and/or to reduce downforce from the ground engaging tool 20. In addition, the controller 40 may transmit a signal to remaining electric motors 22 coupled to nearby ground engaging tools 20 (e.g., in a same row and/or a same column as the clogged ground engaging tool 20) to increase force to substitute for removing the clogged ground engaging tool 20. In this way, operational efficiency may be improved.

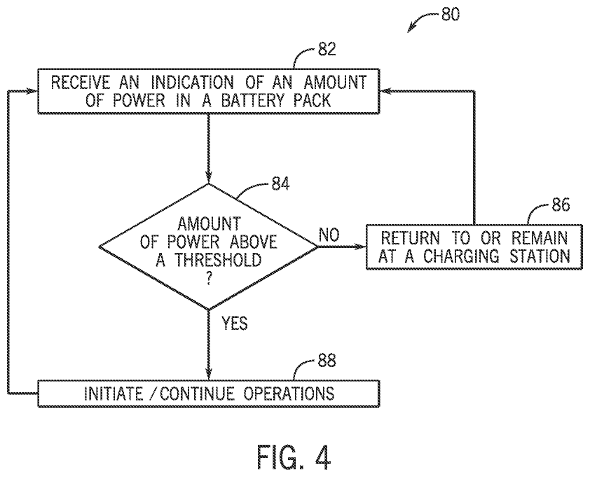

FIG. 4 is a flowchart of an example method 80 for operating the tillage implement 10. The method 80 described herein may be stored on one or more tangible, non-transitory, machine-readable media and/or may be performed by the processor 50 of the controller 40 described herein and/or on other suitable processors. The steps of the method 80 may be performed in the order disclosed herein or in any other suitable order. Furthermore, certain steps of the method 80 may be omitted.

At block 82, the controller receives an indication of an amount of power in a battery pack. The controller may receive a percentage, a ratio, a fraction, or the like of the amount of power remaining in the battery pack. For example, the tillage implement may run for twenty-five minutes, and the controller may receive an indication that 50 percent of power (e.g., relative to a maximum power; battery capacity) remains in the battery pack. In another example, the tillage implement may run for ten minutes and the controller may receive an indication that three-quarters of the power remains in the battery pack.

At block 84, the controller determines if the amount of power is above the power threshold. The power threshold may be set by the operator and/or the controller. For example, the power threshold may be an amount of power used by the tillage implement to return to the charging station (e.g., expected or predicted amount of power based on a location of the tillage implement relative to the charging station, soil conditions, and/or other factors). In another example, the power threshold may be a portion of the amount of power used to return to the charging station. That is, the controller may determine an amount of power that is expected to be provided by the solar panels to determine the power threshold.

If the amount of power is not above the power threshold, then at block 86, the controller instructs the tillage implement to move towards the charging station. The controller may determine the location of the tillage implement and transmit a signal indicative of a path to take back to the charging station. In addition, the controller may transmit a signal to the one or more electric motors to drive the ground engaging tools and move the tillage implement toward the charging station. The controller may transmit a subsequent signal to the tillage implement to cause the charging port to plug itself into the charging station. As such, the battery pack may be charged for subsequent operations. In certain instances, the controller may receive an indication when the battery pack is fully charged (e.g., 100 percent) or otherwise at the charge threshold. In other instances, the controller may store an amount of time needed for the battery pack to be fully charged or to reach the charge threshold. After the amount of time, the method 80 may proceed to block 88 to initiate the tilling operations.

If the amount of power is greater than the power threshold, then at block 88, the controller instructs the tillage implement to initiate or continue the tilling operations. For example, the controller transmits a signal to the ground engaging tools to operate by breaking the soil and/or moving the tillage implement. In certain instances, the tillage implement may be performing the tilling operations. The controller may transmit an additional signal to continue the tilling operations. In other instances, the controller may not transmit a signal to allow the tillage implement to continue the tilling operations. As such, the tillage implement may autonomously determine the amount of power within the battery pack, perform operations, and/or return to the charging station for charging operations.

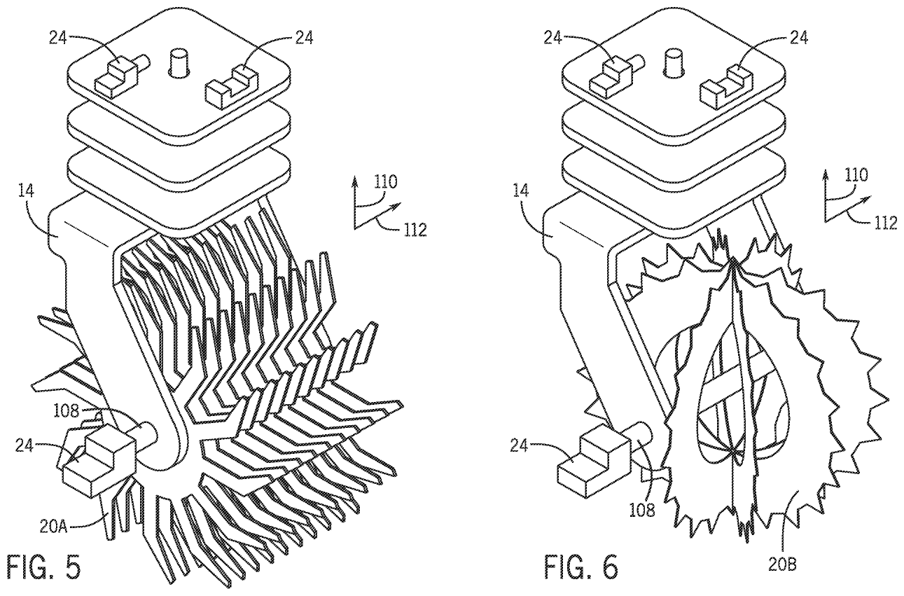

FIGS. 5-7 are close-up views of embodiments of the ground engaging tools 20 coupled to a respective cultivator shank 14. As shown, a respective electric motor 22 and a respective sensor 24 may be coupled to the respective cultivator shank 14. Together, one of the ground engaging tools 20 and its respective cultivator shank 14, its respective electric motor 22, and/or its respective sensor 24 may form a tool assembly (e.g., rotary tillage tool assembly). The ground engaging tools 20 are used for vertical tillage, which may be less disruptive and/or aggressive in comparison to traditional (e.g., horizontal) tillage methods. For example, the ground engaging tools 20 loosen the soil to a depth of several centimeters without turning over the soil. Each of the ground engaging tools 20 penetrates the soil along a vertical axis 110 and rotates about a horizontal axis 112, which in certain positions of the ground engaging tools 20 relative to the frame 12 of the tillage implement 10 may align with the vertical axis 6 and the lateral axis 4 of the tillage implement 10 shown in FIG. 1.

As discussed herein, the one or more electric motors 22 adjust operation of the ground engaging tools 20. The electric motor 22 may be a bi-directional motor that controls a rotational speed of the ground engaging tool 20 and/or a rotational direction of the ground engaging tool 20 and/or a position of the ground engaging tool 20 relative to the frame of the tillage implement 10 shown in FIG. 1. As illustrated, the electric motor 22 includes a first electric motor 22A coupled to the cultivator shank 14 along the vertical axis 110, and a second electric motor 22B coupled to a lateral axle (e.g., horizontal axle) that is fixed (e.g., non-rotatably coupled) to the ground engaging tool 20 along the horizontal axis 112.

The first electric motor 22A adjusts an angle of the ground engaging tool 20 relative to the frame 10 of the tillage implement 10 of FIG. 1 and relative to the surface of the soil, which may provide steering of the tillage implement 10 and/or improve the tilling operations. For example, the first electric motor 22A may rotate at least a portion of the tool assembly (e.g., including the ground engaging tool 20) about the vertical axis 110. In some embodiments, the first electric motor 22A may rotate a vertical axle that is fixed (e.g., non-rotatably coupled) to a lower-most horizontal plate (e.g., bracket) that is coupled between two opposed arms of the cultivator shank 14 to thereby rotate at least the portion of the tool assembly about the vertical axis. However, it should be appreciated that any of a variety of configurations may be implemented to enable this rotation.

The angle determines the amount of soil being lifted and mixed as the ground engaging tool 20 moves through the field. For example, a smaller angle relative to the forward direction of travel, such as an acute angle, may disturb the soil less than a larger angle, such as an obtuse angle relative to the forward direction of travel. In other words, setting the operating parameters of the ground engaging tool 20 to a target obtuse angle may provide more soil mixing in comparison to setting the ground engaging tool 20 to an acute angle. In addition, adjusting the angle of the ground engaging tool 20 may control a movement of the tillage implement 10 within the field. For example, increasing the angle may result in the tillage implement 10 turning within the field. In certain instances, the first electric motor 22A may adjust a position of the ground engaging tool 20 along the vertical axis 110, such as raising or lowering the ground engaging tool 20. For example, the first electric motor 22A may control a depth of the ground engaging tool 20 within the top layer of soil. It should be appreciated that the controller 40 of FIG. 2 may control the ground engaging tools 20 of the tillage implement 10 in a coordinated manner to steer the tillage implement 10 through the field (e.g., turning all; turning some and adjusting downforce of some or all to achieve desired tilling and steering functionality).

The second electric motor 22B may adjust (e.g., increase, decrease) a rotational speed of the ground engaging tool 20 via rotation of the lateral axle 108. For example, a faster rotational speed may cause the ground engaging tool 20 to cut through the soil at a quicker speed in comparison to a slower rotational speed. However, operating at the faster rotational speed may cause the second electric motor 22B and/or the ground engaging tool 20 to consume more power in comparison to slower rotational speeds. In addition, the second electric motor 22B may adjust a torque (e.g., force) of the ground engaging tool 20. For example, increasing the rotational speed may increase the torque of the ground engaging tool 20, which may allow the ground engaging tool 20 to break through tougher, more compact, soil.

The tillage implement 10 also includes the sensor 24, which may be positioned to detect operational parameters of the ground engaging tool 20. For example, the sensor 24 may be a laser sensor that monitors an angle between the ground engaging tool 20 and the surface of the soil. In another example, the sensor 24 may be a rotational sensor that monitors operation of the ground engaging tool 20. The sensor 24 may determine if the ground engaging tool 20 is operational, such as if the ground engaging tool 20 rotates, or is not operational, such as if the ground engaging tool 20 is clogged, damaged, and/or does not rotate.

The controller 40 may receive sensor data from the sensor 24 and determine if the ground engaging tool 20 is operating within the operating parameters. If the ground engaging tool 20 is not operating within the operating parameters, then the controller 40 adjusts operation of the ground engaging tool 20. For example, the controller 40 may transmit a signal to the first electric motor 22A to cause adjustment of the angle to correspond with a target angle. Additionally or alternatively, the controller 40 may transmit a signal to the second electric motor 22 to adjust a rotational speed of the ground engaging tool 20 to correspond with a target rotational speed. Additionally or alternatively, the controller 40 may display the sensor data (e.g., operational characteristics of the ground engaging tool 20) on a display to the operator. The operator may adjust the operational parameters of the ground engaging tool 20 via inputs at the display. The controller 40 may receive the updated operating parameters and transmit a signal to the first electric motor 22A, the second electric motor 22B, or both to cause the tillage implement 10 to operate based on the updated operating parameters. In this way, the tillage implement 10 may be at least partially autonomous (e.g., operated via commands from the controller 40 based on programmed commands and data, such as sensor data; with or without inputs from the operator who is located off-board or remotely from the tillage implement; without the operator on-board the tillage implement 10), which may reduce costs of the tilling operation.

With the foregoing in mind, FIG. 5 is a close-up view of an embodiment of the ground engaging tool 20 of the tillage implement 10 as a rotary tine 20A. The rotary tine 20A includes a series of spokes that are distributed circumferentially about and extend outwardly from a center opening of the rotary tine 20A that receives the lateral axle 108. The spokes may penetrate the soil by a few centimeters to loosen the soil without turning it over. To this end, the spokes may be made of any suitable material, such as metal. The operating parameters of the rotary tine 20A are controlled by the electric motor 22. For example, the first electric motor 22A may adjust an angle between the rotary tine 20A and the soil, while the second electric motor 22B may adjust the rotational speed of the rotary tine 20A. Increasing the angle between the rotary tine 20A and the soil may increase the amount of soil being loosed by the rotary tine 20A. In addition, the rotary tine 20A may support the weight of the tillage implement 10 without compressing the soil, thereby improving the tilling operation.

FIG. 6 a close-up view of an embodiment of the ground engaging tool 20 of the tillage implement 10 as a roto tiller assembly 20B. The roto tiller assembly 20B include multiple tines (e.g., plates) distributed circumferentially about the vertical axis 110, and each of the multiple tines includes a curved radially outer edge with a series of teeth (e.g., protrusions; spokes). Each of the tines may be spaced by any suitable distance. For example, tines spaced closer together may create finer soil during the tilling operations in comparison to tines aligned farther away. As illustrated, the tines include curved tines that cut into the soil and lift the soil along the vertical axis 110. In other instances, the tines may include straight tines, winged tines, or any combination thereof. The roto tiller assembly 20B may loosen the soil more aggressively in comparison to the rotary tine 20A. For example, each of the tines may be longer (e.g., larger) in comparison to the spokes of the rotary tine 20A. As such, the tines may lift and mix more soil in comparison to the rotary tine 20A.

For a more aggressive tilling operation, the operator may install more roto tiller assembly 20B than rotary tine 20A. As such, the tilled soil may be looser, finer, and/or include smaller particle sizes. For a less aggressive tilling operation, the operator may install more rotary tine 20A in comparison to roto tiller assembly 20B. As such, the tillage implement may be adjusted based on a desired tilling operation.

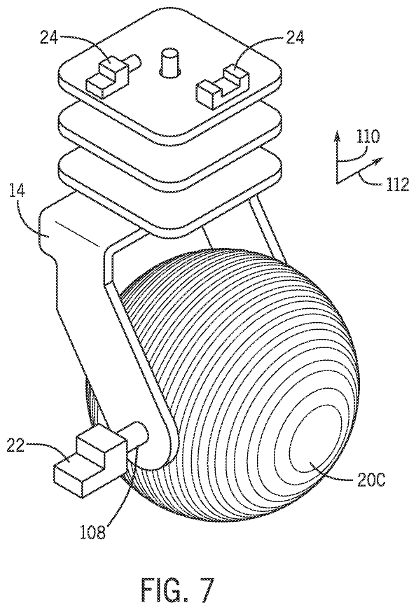

FIG. 7 a close-up view of an embodiment of the ground engaging tool 20 of the tillage implement 10 as a roller 20C. The roller 20C includes a ball (e.g., roller) and may include ridges along an outer surface. The roller 20C supports the weight of the tillage implement 10 and/or supports movement of the tillage implement 10. For example, the roller 20C maneuvers the tillage implement 10 within the field. The weight of the tillage implement 10 may be distributed across the roller 20C, while the ridges create small holes in the soil to loosen and/or break up the soil. For example, a larger roller may distribute the weight across a larger area of the soil in comparison to a smaller roller. In addition, the roller 20C may support movement of the tillage implement 10. For example, adjusting an angle between the roller 20C and the soil via the first motor 22A may cause the tillage implement 10 to turn in the field.

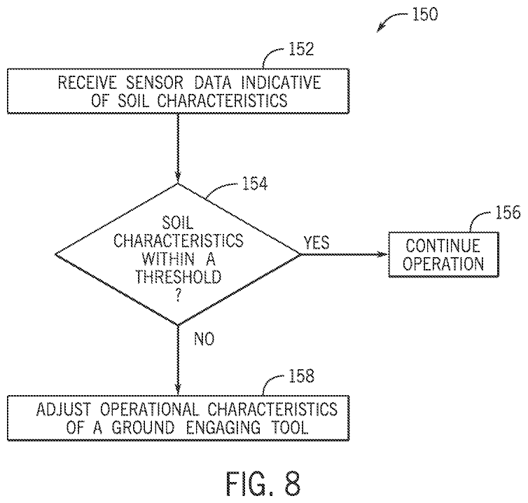

FIG. 8 is a flowchart of an example method 150 for operating the tillage implement 10 based on sensor data indicative of soil characteristics. The method 150 described herein may be stored on one or more tangible, non-transitory, machine-readable media and/or may be performed by the processor 50 of the controller 40 described herein and/or on other suitable processor(s). The steps of the method 150 may be performed in the order disclosed herein or in any other suitable order. Furthermore, certain steps of the method 150 may be omitted.

At block 152, the controller receives a sensor data indicative of soil characteristics. The soil characteristics may include soil density, soil texture, soil color, particle sizes of the soil, compactness of the soil. For example, the sensor includes multiple sensors positioned on the tillage implement to determine the soil characteristics prior to the tillage implement loosening to the soil and/or after the tillage implement has loosened the soil.

At block 154, the controller determines if the soil characteristics are within a threshold soil characteristic (e.g., target soil characteristics). The threshold soil characteristic may be set by the operator, such as via a display, and/or may include target soil characteristics stored in a database, such as the memory. For example, the sensor data indicates a particle size of the soil after the tilling operation. The controller may determine an average particle size and compare the average particle size to a target particle size indicated by the operator and/or stored in the database. Additionally or alternatively, the sensor data indicates a level of the surface of the soil after the tilling operations. The controller may compare the level of the surface to a target level, such as an angle or degree offset, indicated by the operator and/or stored in the database. Additionally or alternatively, the sensor data indicates a soil density of the soil after the tilling operation. The controller may compare the soil density to a target soil density set by the operator and/or stored in the database.

If the soil characteristics are within the threshold soil characteristic, then at block 156, the controller transmits a signal indicative of continuing the tilling operations. For example, the controller transmits a signal to the first electric motor, the second electric motor, or both to drive the ground engaging tools. In another example, the controller may not transmit a signal and the tillage implement may continue to operate based on previously set (e.g., currently employed) operating parameters.

If the soil characteristics are not within the threshold soil characteristic, then at block 158, the controller transmits a signal indicative of adjusting operational characteristics of a ground engaging tool. For example, the soil density may be greater than the target soil density. As such, the controller may transmit a signal to the first electric motor, the second electric motor, or both to increase the rotational speed and/or the angle of the ground engaging tool. In another example, the average particle size of the soil may be less than the target particle size, and the controller may transmit a signal to decrease the rotational speed of the ground engaging tool. As such, the tillage implement may be autonomously controlled based on operator inputs and/or target soil characteristics. It should be appreciated that these steps may carry out these steps to control each of the ground engaging tools of the tillage implement simultaneously and/or in a coordinated manner (e.g., to achieve the target soil characteristics and/or travel over the field).

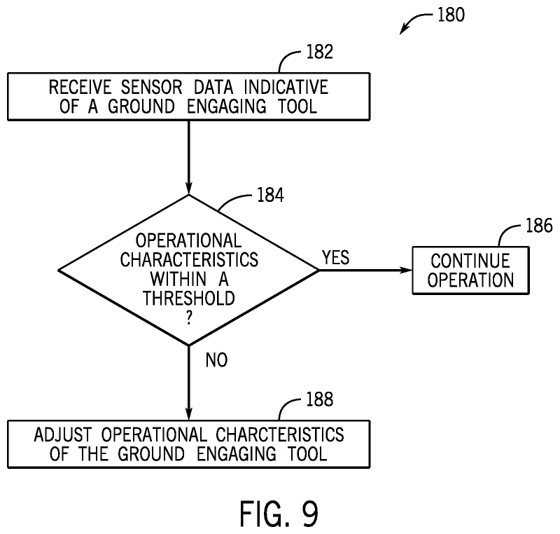

FIG. 9 is a method 180 for operating the tillage implement 10 based on sensor data indicative of operating parameters of the ground engaging tool 20. The method 180 described herein may be stored on one or more tangible, non-transitory, machine-readable media and/or may be performed by the processor 50 of the controller 40 described herein and/or on other suitable processor(s). The steps of the method 180 may be performed in the order disclosed herein or in any other suitable order. Furthermore, certain steps of the method 180 may be omitted.

At block 182, the controller receives sensor data indicative of a ground engaging tool. For example, the sensor data may be indicative of operational parameters of the ground engaging tool. For example, the sensor data may be indicative of an angle between the ground engaging tool and the soil (e.g., and the forward direction of travel). In another example, the sensor data may be indicative of the depth of the ground engaging tool. In addition, the sensor data may include a position (e.g., along the vertical axis) of the ground engaging tool relative to the tillage implement. In this way, the controller may individually control the ground engaging tools.

At block 184, the controller determines if the operational parameters are different from a threshold operating parameter (e.g., target operational parameter). Each threshold operating parameter may be indicated as a range of parameters. For example, the operator may set a rotational speed or a range of rotational speeds for the ground engaging tool. In another example, the operator may set a rotational speed, and the controller may set a tolerance value, such as ±0.5. As such, the controller may compare the sensor data to a range of rotational speeds. In certain instances, the sensor data may include a profile (e.g., outline, trace) of the ground engaging tool, and the controller may compare the profile to a target profile of the ground engaging tool to determine an operational status (e.g., operational, not operational). In other instances, the sensor data may indicate the ground engaging tool is clogged, such as when no or little rotational movement is detected. The controller may transmit a signal to notify the operator of the clogged ground engaging tool. For example, the controller may populate a graphical user interface on the display with the position or location of the ground engaging tool. As such, efficiency of maintenance operations may be improved.

If the operational parameters are within the threshold operating parameter, at block 186, the controller transmits a signal to continue operation, similar to block 156 described with respect to FIG. 8. If the operational parameters are not within the threshold operating parameter, at block 188, the controller transmits a signal to adjust the operation, similar to block 158 described with respect to FIG. 8. For example, the controller may transmit a signal to cause an adjustment to a position of a non-operational ground engaging tool, such as lifting the ground engaging tool from the surface of the soil. The controller may transmit a notification to the operator to perform maintenance operations on the tillage implement when the tillage implement returns to the charging station. In this way, the tillage implement 10 may be autonomously controlled by the controller based on sensor data, programmed settings, operational characteristics set by the operator, and/or other sources of information (e.g., databases), thereby improving operational efficiency.

It should be appreciated that any features shown or described with reference to FIGS. 1-9 may be combined in any suitable manner to provide a tillage implement that is capable of autonomous operation. The autonomous operation may include fully autonomous operation, semi-autonomous operation, and/or remotely-controlled operation. For example, the autonomous operation may include controlling the tillage implement to drive through a field (e.g., make multiple passes, including turns) to perform tillage operations without real-time inputs from a human operator on-board the tillage implement or remotely located from the tillage implement. The autonomous operation may also include controlling the tillage implement to drive to a storage/charging location to perform charging operations without real-time inputs from a human operator on-board the tillage implement or remotely located from the tillage implement. Further, the autonomous operation may also include controlling the tillage implement to drive without carrying a human operator on-board the tillage implement. Thus, the autonomous operation may include controlling the tillage implement to drive based on a controller utilizing programmed settings (e.g., stored autonomous driving algorithms) and sensor data and other information, such as weather forecasts, light levels, current power storage levels, solar power capabilities, fields maps, thresholds, and so forth.

It should be appreciated that the autonomous operation may include certain inputs from a human operator, such as inputs to establish desired or target soil characteristics during the tillage operations. However, the certain inputs from the human operator may be provided via a mobile device that is physically separate from the tillage implement and/or that is located remotely from the tillage implement (e.g., in a monitor or control station along a side of the field, several kilometers away from the field, or in any location that enables remote communications). Advantageously, the tillage implement described herein may utilize various sources of power, such as power obtained and stored via a charging port and/or solar power obtained via solar panels. Additionally, the tillage implement described herein may be a compact structure that utilizes at least some of the ground engaging tools to steer the tillage implement over the soil (e.g., without traditional cylindrical wheels or tires that may compact the soil).

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

1. A tillage implement, comprising:
at least one electric motor coupled to a ground engaging tool;
a power storage component configured to store power and to provide the power to the at least one electric motor; and
a controller communicatively coupled to the at least one electric motor and the power storage component, wherein the controller comprises a memory and a processor, and the controller is configured to:
provide instructions to the at least one electric motor to adjust a rotational speed of the ground engaging tool, an angle of the ground engaging tool relative to a soil surface, or both.

2. The tillage implement of claim 1, comprising at least one sensor, wherein the controller is configured to:
receive sensor data from the at least one sensor;
determine operational characteristics of the ground engaging tool;
determine the operational characteristics of the ground engaging tool are outside of a target range; and
in response, provide the instructions to the at least one electric motor to adjust the rotational speed of the ground engaging tool, the angle of the ground engaging tool relative to the soil surface, or both.

3. The tillage implement of claim 1, comprising at least one sensor, wherein the controller is configured to:
receive sensor data indicative of soil characteristics from the at least one sensor;
determine the soil characteristics are outside of a target range; and
in response, provide the instructions to the at least one electric motor to adjust the rotational speed of the ground engaging tool, the angle of the ground engaging tool relative to the soil surface, or both.

4. The tillage implement of claim 1, wherein the controller is configured to:
receive an indication of an amount of power within the power storage component;
compare the amount of power to a power threshold; and
in response to the amount of power being below the power threshold, provide the instructions to the at least one electric motor to adjust the rotational speed of the ground engaging tool, the angle of the ground engaging tool relative to the soil surface, or both to drive the tillage implement to a charging station.

5. The tillage implement of claim 4, wherein the controller is configured to dynamically calculate the power threshold based on sensor data indicative of soil characteristics.

6. The tillage implement of claim 1, comprising at least one solar panel configured to generate electrical power for use by the at least one electric motor.

7. The tillage implement of claim 6, wherein the power storage component is a main power source for the tillage implement, and the at least one solar panel is a back up power source for the tillage implement.

8. The tillage implement of claim 1, wherein the at least one electric motor comprises:
a first electric motor coupled to the ground engaging tool and configured to adjust the rotational speed of the ground engaging tool; and
a second electric motor coupled to the ground engaging tool and configured to adjust the angle of the ground engaging tool relative to the soil surface.

9. The tillage implement of claim 1, wherein the ground engaging tool comprises a rotary tiller assembly, a rotary tine, or a roller.

10. The tillage implement of claim 1, comprising a first set of ground engaging tools and a second set of ground engaging tools, wherein the ground engaging tool is part of the first set of ground engaging tools, the first set of ground engaging tools is distributed laterally across the tillage implement to form a first row of ground engaging tools, the second set of ground engaging tools is distributed laterally across the tillage implement to form a second row of ground engaging tools.

11. The tillage implement of claim 1, comprising a plurality of additional ground engaging tools and a plurality of additional electric motors, wherein each additional ground engaging tool of the plurality of additional ground engaging tools is coupled to at least one respective electric motor of the plurality of additional electric motors, and the power storage component is configured to provide the power to the plurality of additional electric motors.

12. The tillage implement of claim 1, wherein the controller is configured to execute one or more autonomous driving algorithms to drive the tillage implement through the field without real-time inputs from a human operator.

13. A method for operating an autonomous tillage implement, the method comprising:
accessing, using a processor, target operational characteristics for a plurality of ground engaging tools of the autonomous tillage implement; and
executing, using the processor, one or more autonomous driving algorithms to provide instructions to a plurality of electric motors to adjust the plurality of ground engaging tools to steer the autonomous tillage implement through a field and to maintain the plurality of ground engaging tools at the target operational characteristics to carry out tillage operations as the autonomous tillage implement travels through the field.

14. The method of claim 13, comprising:
monitoring, using the processor, a power level of a power storage component that provides power to the plurality of electric motors as the autonomous tillage implements travels through the field; and
executing, using the processor, the one or more autonomous driving algorithms to provide the instructions to the plurality of electric motors to adjust the plurality of ground engaging tools to steer the autonomous tillage implement to a recharging station in response to the power level being below a power threshold.

15. The method of claim 13, comprising instructing, using the processor, operation of a solar panel of the autonomous tillage implement to provide power to the plurality of electric motors.

16. The method of claim 10, comprising:
receiving, at the processor, sensor data indicative of operational characteristic of the plurality of ground engaging tools as the autonomous tillage implement travels through the field; and
providing, using the processor, the instructions to the plurality of electric motors to adjust the plurality of ground engaging tools to based on the sensor data to maintain the operational characteristics of the plurality of ground engaging tools at the target operational characteristics.

17. The method of claim 10, wherein providing the instructions to the plurality of electric motors comprises:
transmitting a first control signal to a first electric motor of the plurality of electric motors, wherein the first electric motor is coupled to a first ground engaging tool of the plurality of ground engaging tools to adjust a rotational speed of the first ground engaging tool; and
transmitting a second control signal to a second electric motor of the plurality of electric motors, wherein the second electric motor is coupled to the first ground engaging tool to adjust an angle between the first ground engaging tool and a soil surface.

18. An autonomous tillage implement, comprising:
a power storage component coupled to a frame of the autonomous tillage implement and configured to store power;
a plurality of ground engaging tools coupled to the frame;
a plurality of electric motors, wherein each electric motor of the plurality of electric motors coupled to the power storage component and a respective ground engaging tool of the plurality of ground engaging tools; and
a controller coupled to the power storage component and the plurality of electric motors, and comprising a memory and a processor, wherein the controller is configured to:
provide respective instructions to each electric motor of the plurality of electric motors to independently adjust a respective rotational speed of the respective ground engaging tool of the plurality of ground engaging tool, a respective angle of the respective ground engaging tool of the plurality of ground engaging tools, or both.

19. The autonomous tillage implement of claim 18, comprising a solar panel coupled to the frame, and wherein the controller is configured to
provide additional power generated by the solar panel to operate the plurality of electric motors.

20. The autonomous tillage implement of claim 18, wherein the plurality of ground engaging tools comprise:
a roto tiller assembly configured to loosen soil;
a rotary tine configured to loosen the soil and support a weight of the autonomous tillage implement; and
a roller configured to maneuver the autonomous tillage implement and support the weight of the autonomous tillage implement.
